(19) United States
(12) Patent Application Publication
(10) Pub. No.: US 2016/0023385 A1
(43) Pub. Date: Jan. 28, 2016

(54) FORMED LIGNEOUS BODY AND METHOD OF PRODUCING THE SAME

(71) Applicant: KOJIMA INDUSTRIES CORPORATION, Toyota-Shi (JP)

(72) Inventors: Kimihiro NAGASE, Toyota-Shi (JP); Kozo KANAYAMA, Nagoya-Shi (JP); Tsunehisa MIKI, Nagoya-Shi (JP); Ichinori SHIGEMATSU, Nagoya-Shi (JP); Masako SEKI, Nagoya-Shi (JP)

(21) Appl. No.: 14/793,031

(22) Filed: Jul. 7, 2015

(30) Foreign Application Priority Data
Jul. 25, 2014 (JP) 2014-151376

(51) Int. Cl. B29C 43/18; B29C 43/20; B29C 43/52; B29C 43/44; B44C 1/20; B29C 35/02

(52) U.S. Cl. CPC B29C 43/18; B44C 1/20; B29C 35/02; B29C 43/52; B29C 43/44; B29C 43/203; B29L 2031/10

(57) ABSTRACT

A formed ligneous body having a clear layer integrally formed on the side of its front surface, with a predetermined thickness and a high degree of adhesiveness, and a decorative design surface presenting a deep and excellent appearance, and a method of advantageously producing a formed ligneous body presenting an excellent decorative design. The formed ligneous body has a ligneous substrate whose front surface serves as the decorative design surface and the translucent clear layer integrally formed on the decorative design surface, wherein the ligneous substrate is formed by subjecting a ligneous material impregnated with a thermosetting resin material to a flow molding process, and the clear layer is formed by heating and pressing at least one fibrous sheet constituted by plant fibers and impregnated with a thermosetting resin material, together with the ligneous material during the flow molding process, so that each of the fibrous sheet is made transparent.

### CROSS REFERENCE TO RELATED APPLICATION

The present application is based on Japanese Patent Application No. 2014-151376 filed on Jul. 25, 2014 the contents of which are incorporated herein by reference.

### BACKGROUND OF THE INVENTION

1. Field of the Invention

The present invention relates generally to a formed ligneous body and a method of producing the same, and more particularly to a formed ligneous body having a decorative design surface giving a deep appearance, and a method which permits advantageous production of the formed ligneous body.

2. Description of Related Art

There have been widely used formed ligneous bodies formed from various kinds of lumber (timber) and bamboo, as components of architectural floor panels, furniture and fittings. In the field of automotive vehicles, for example, there has been a growing demand for interior parts having a texture or appearance of wood, keeping pace with an increased desire for enhancement of quality of the vehicles. To meet this growing demand, formed ligneous bodies have been increasingly utilized as outer panels and surface panels of the interior parts of the automotive vehicles.

Japanese Patent No. 4502848 and Japanese Patent No. 4849609 disclose a formed ligneous body produced by utilizing a so-called “flow molding” process, and a method of producing such a formed ligneous body. The formed ligneous body produced by utilizing the flow molding process has not only an advantage regarding the preservation of resources and environment, but also an advantage of presenting a genuine lumber feel. Further, JP-A-2012-161932 discloses a method of producing a formed body of a plant-derived material, including a step of impregnating the plant-derived material with a thermosetting resin (an additive) such as a phenolic resin and a step of subjecting the plant-derived material to a heating and pressing process to form the plant-derived material into a desired shape. These steps permit an easy flow of the plant-derived material, making it possible to assure a high degree of uniformity of dynamic properties of the formed ligneous body.

By the way, it is known to form a clear layer with a suitable thickness in a part of the formed ligneous body on the side of its front surface (decorative design surface), for advantageously assuring scratch-, water- and weather-proof properties of the front surface, and improving excellence in decorative design of the formed ligneous body. As methods for forming such a clear layer, there have been proposed: a method of forming a clear coating film by coating; a method of forming a clear layer by injection molding using an acrylic resin or the like (see JP-A-2013-103421, for example); and a method of forming a surface-reinforcing layer by impregnating a fibrous sheet with a synthetic resin liquid applied to a surface of a substrate, and curing the synthetic resin liquid (see JP-A-2002-172604, for example).

However, the method of forming the clear coating film by coating has a problem of an undesirable increase of the production cost, since a coating operation is required to be performed plurality of times in order to form the clear layer with the suitable thickness. The method of forming the clear layer by injection molding and the method of forming the surface-reinforcing layer described above also have the problem of the increase of the production cost, since a mold or other additional apparatus and additional processes are required to form the clear layer (the surface-reinforcing layer), and further have an inherent problem of difficulty in assuring sufficient adhesiveness between the body (a sliced veneer or the substrate) of the formed ligneous body and the clear layer.

### SUMMARY OF THE INVENTION

In view of the prior art described above, the applicants conceived an idea of solving the above-described problems by forming the formed ligneous body by the flow molding process, and integrally forming the clear layer in the part of the formed ligneous body on the side of its front surface (on the decorative design surface of a ligneous substrate), within a forming cavity in which a ligneous material is subjected to the flow molding process. Based on this idea, the applicants made various studies, and found that there still remain problems to be solved, as described below.

Namely, where a resin material which is used in a liquid state for forming the clear layer and which has fluidity is placed within the forming cavity before the flow molding process, an excessively large amount of flow of the resin material and leakage of the resin material from the forming cavity may be caused by a pressing force applied to the resin material during the flow molding process, so that it is difficult to form the clear layer with a desired thickness. In this case, the clear layer cannot sufficiently exhibit its effect of giving a glossy or deep appearance to the decorative design surface, so that there arises a problem of deterioration of decorative design of the formed ligneous body. In this respect, it is noted that translucency of the clear layer as a whole decreases in proportion to a thickness of the clear layer, so that in order to give the formed ligneous body an excellent decorative design, it is necessary to increase the translucency per unit thickness of the clear layer.

On the other hand, where a conventional transparent thermoplastic film is used in place of the above-described resin material for forming the clear layer, the desired thickness of the clear layer can be assured. However, close adhesiveness between the thermoplastic film and the ligneous material impregnated with a thermosetting resin to facilitate the flow molding process is insufficient, so that there arises another problem that the clear layer (the thermoplastic film) suffers from cracking or peeling from the ligneous material.

The present invention was made under the circumstances described above. It is therefore a first object of the present invention to provide a formed ligneous body including a decorative design surface giving a deep and excellent appearance, and a clear layer integrally formed with a suitable thickness on the side of its front surface with a high degree of adhesiveness. It is a second object of the present invention to provide a method which permits advantageous industrial production of such a formed ligneous body having excellence in decorative design.

The first object described above can be achieved according to a first aspect of the invention, which provides a formed ligneous body having a ligneous substrate whose front surface serves as a decorative design surface, and a clear layer which is integrally formed on the decorative design surface of the ligneous substrate and which has translucency, wherein the ligneous substrate is formed by subjecting a ligneous material impregnated with a thermosetting resin material, to a flow molding process in which the ligneous material is heated and pressed such that the ligneous material is forced to flow and shaped while the ligneous material is compressed, and the clear layer is formed by heating and pressing at least one fibrous sheet constituted by plant fibers and impregnated with a thermosetting resin material, together with the ligneous material during the flow molding process, so that the at least one fibrous sheet is made transparent.

In the formed ligneous body according to the first aspect of the invention, the thermosetting resin material contained in the ligneous material and the thermosetting resin material contained in the at least one fibrous sheet are preferably chemically combined with each other and cured, whereby the clear layer is integrally formed on the decorative design surface of the ligneous substrate formed by the flow molding process. In this respect, it is noted that the expression “chemically combined with each other” is interpreted to comprehend “polymerized together” and “mixed together since these resin materials are the same thermosetting resin material”.

In one preferred form of the formed ligneous body according to the first aspect of the invention, the thermosetting resin material contained in the ligneous material of the ligneous substrate is at least one of a melamine resin and a urea resin, and the thermosetting resin material contained in the at least one fibrous sheet of the clear layer is at least one of the melamine resin and the urea resin. In a more preferred form of the formed ligneous body according to the first aspect of the invention, the thermosetting resin material contained in the ligneous material of the ligneous substrate and the thermosetting resin material contained in the at least one fibrous sheet of the clear layer is the same thermosetting resin material.

In other preferred form of the formed ligneous body according to the first aspect of the invention, both of the thermosetting resin material contained in the ligneous material of the ligneous substrate and the thermosetting resin material contained in the at least one fibrous sheet of the clear layer are a melamine resin.

In other preferred form of the formed ligneous body according to the first aspect of the invention, the at least one fibrous sheet contains at least one additive selected from the group consisting of a coloring agent, a light resistant agent, an ultraviolet-absorbing agent, a heat-absorbing agent and an anti-oxidizing agent, together with the thermosetting resin material, so that the clear layer contains the at least one additive.

In other preferred form of the formed ligneous body according to the first aspect of the invention, the clear layer has a thickness within a range of 400-600 μm.

In still other preferred form of the formed ligneous body according to the first aspect of the invention, the ligneous material includes a sliced veneer which is sliced from a lumber in a direction parallel to a direction of extension of fibers of the lumber and which is impregnated with the thermosetting resin material, and a sliced veneer layer is formed from the sliced veneer in a portion of the ligneous substrate on the side of its front surface.

The second object described above can be achieved according to a second aspect of the invention, which provides a method of producing the formed ligneous body according to the first aspect of the invention, comprising the steps of: (a) providing a ligneous material impregnated with a thermosetting resin material and at least one fibrous sheet constituted by plant fibers and impregnated with a thermosetting resin material; (b) accommodating the ligneous material and the at least one fibrous sheet in a forming cavity, such that the at least one fibrous sheet is placed on the side of a cavity surface and the ligneous material is superposed on the at least one fibrous sheet; (c) heating and pressing the at least one fibrous sheet while subjecting the ligneous material to a flow molding process by heating and pressing the ligneous material in the forming cavity such that the ligneous material is forced to flow and shaped while the ligneous material is compressed in a direction of mutual superposition of the ligneous material and the at least one fibrous sheet; and (d) curing or solidifying the thermosetting resin materials respectively contained in the ligneous material and in the at least one fibrous sheet, while heating and pressing the ligneous material and the at least one fibrous sheet, so that the at least one fibrous sheet is made transparent, and the ligneous substrate and the clear layer are formed integrally with each other in the forming cavity.

In one preferred form of the method according to the second aspect of the invention, the ligneous material is a rectangular block cut from a lumber in a direction perpendicular to a direction of extension of fibers of the lumber.

In other preferred form of the method according to the second aspect of the invention, the at least one fibrous sheet comprises a plurality of fibrous sheets, and the plurality of fibrous sheets are superposed on each other and accommodated within the forming cavity.

The second object described above can be also achieved according to a third aspect of the invention, which provides a method of producing the formed ligneous body according to the first aspect of the invention, comprising the steps of: (a) providing a ligneous material which includes a sliced veneer and which is impregnated with a thermosetting resin material, and at least one fibrous sheet constituted by plant fibers and impregnated with a thermosetting resin material; (b) accommodating the ligneous material and the at least one fibrous sheet in a forming cavity, such that the at least one fibrous sheet is placed on the side of a cavity surface, and the ligneous material is superposed on the at least one fibrous sheet such that the sliced veneer is disposed on the side of the at least one fibrous sheet; (c) heating and pressing the at least one fibrous sheet while subjecting the ligneous material to a flow molding process by heating and pressing the ligneous material in the forming cavity, such that the ligneous material is forced to flow and shaped while the ligneous material is compressed in a direction of mutual superposition of the ligneous material and the at least one fibrous sheet; and (d) curing or solidifying the thermosetting resin materials respectively contained in the ligneous material and in the at least one fibrous sheet, while heating and pressing the ligneous material and the at least one fibrous sheet, so that the at least one fibrous sheet is made transparent, and the ligneous substrate and the clear layer are formed integrally with each other in the forming cavity.

In the formed ligneous body according to the present invention, the clear layer having translucency is integrally formed on the decorative design surface of the ligneous substrate, by practicing the flow molding process for forming the ligneous substrate using the resin-impregnated ligneous material. In the flow molding process, the at least one fibrous sheet constituted by the plant fibers and impregnated with the thermosetting resin material is heated and pressed, whereby the at least one fibrous sheet is effectively made transparent, and formed into the clear layer having a predetermined thickness. Therefore, the formed ligneous body can be given a deep and excellent appearance of decorative design on the side of its front surface.

Namely, the thermosetting resin material contained in the at least one fibrous sheet is retained among the plant fibers constituting the fibrous sheet. Therefore, upon application of heat and a pressing force on the fibrous sheet during the flow molding process, an excessively large amount of flow of the thermosetting resin material and leakage of the thermosetting resin material from the forming cavity are advantageously prevented, to assure the desired thickness of the clear layer.

The at least one fibrous sheet constituted by the plant fibers and originally having a low degree of translucency is impregnated with the thermosetting resin material, and subjected to heating and pressing operations, whereby the fibrous sheet is made transparent, and translucency of the clear layer of the formed ligneous body can be advantageously improved.

Further, the resin material contained in the at least one fibrous sheet and the resin material contained in the ligneous material are both the thermosetting resin material. Accordingly, while the at least one fibrous sheet and the ligneous material are bonded together under pressure, the resin materials respectively contained in the fibrous sheet and the ligneous material are mixed together or chemically combined with each other, so that adhesiveness between the ligneous substrate and the clear layer is improved, to advantageously prevent cracking and peeling of the clear layer from the ligneous substrate.

The formed ligneous body according to the present invention has a further advantage in that strength of a portion of the formed ligneous body on the side of its front surface can be advantageously improved by a reinforcing effect of the plant fibers constituting the at least one fibrous sheet.

In the above-described method of producing the formed ligneous body according to the present invention, the at least one fibrous sheet is heated and pressed while the ligneous material is subjected to the flow molding process by heating and pressing the ligneous material within the forming cavity, such that the ligneous material is forced to flow and shaped while the ligneous material is compressed in a direction of mutual superposition of the ligneous material and the at least one fibrous sheet. Thus, the heating and pressing operations can be performed on the at least one fibrous sheet concurrently with the flow molding process performed on the ligneous material, to advantageously reduce the production cost of the formed ligneous body.

Further, in the method of producing the formed ligneous body according to the present invention, the resin material contained in the ligneous material and the resin material contained in the at least one fibrous sheet are cured or solidified, while the ligneous material and the at least one fibrous sheet are heated and pressed, whereby the ligneous substrate and the clear layer are formed integrally with each other within the forming cavity. Thus, the ligneous substrate and the clear layer can be effectively integrated into a one-piece body.

### BRIEF DESCRIPTION OF THE DRAWINGS

FIG. 1 is a schematic cross sectional view showing a formed ligneous body according to one embodiment of the present invention;

FIG. 2 is an enlarged schematic view of part A in FIG. 1;

FIG. 3 is a schematic cross sectional view showing an example of a step of a method of production of the formed ligneous body of FIG. 1, in which a ligneous material and paper sheets are set in a forming mold of a heating and pressing device such that the ligneous material and the paper sheets are superposed on each other;

FIG. 4 is an enlarged schematic view of part B in FIG. 3;

FIG. 5 is a schematic cross sectional view showing an example of a step implemented following the step shown in FIG. 3, in which an upper die of the forming mold comes into contact with an upper surface of the ligneous material, in a process of a closing action of the forming mold;

FIG. 6 is a schematic cross sectional view showing an example of a step implemented following the step shown in FIG. 5, in which the ligneous material is subjected to a flow molding process by the heating and pressing device, while the paper sheets are heated and pressed, in a closed state of the forming mold;

FIG. 7 is an enlarged schematic view of part C in FIG. 6;

FIG. 8 is a schematic cross sectional view showing an example of a step implemented following the step shown in FIG. 6, in which resin materials with which the ligneous material and the paper sheets are impregnated are cured or solidified, whereby the formed ligneous body is formed;

FIG. 9 is a schematic cross sectional view corresponding to that of FIG. 1, and showing a formed ligneous body having a structure according to other embodiment of the present invention;

FIG. 10 is an enlarged schematic view of part D in FIG. 9;

FIG. 11 is a plan view taken in a direction of an arrow E in FIG. 9;

FIG. 12 is a schematic cross sectional view corresponding to that of FIG. 3, and showing an example of a step of a method of production of the formed ligneous body shown in FIG. 9;

FIG. 13 is a schematic cross sectional view corresponding to that of FIG. 5, and showing an example of a step implemented following the step shown in FIG. 12;

FIG. 14 is a schematic cross sectional view corresponding to that of FIG. 6, and showing an example of a step implemented following the step shown in FIG. 13; and

FIG. 15 is an enlarged schematic cross sectional view corresponding to that of FIG. 2, and showing a formed ligneous body having a structure according to a further embodiment of the present invention.

### DETAILED DESCRIPTION OF THE INVENTION

To further clarify the present invention, preferred embodiments of the invention will be described in detail by reference to the drawings.

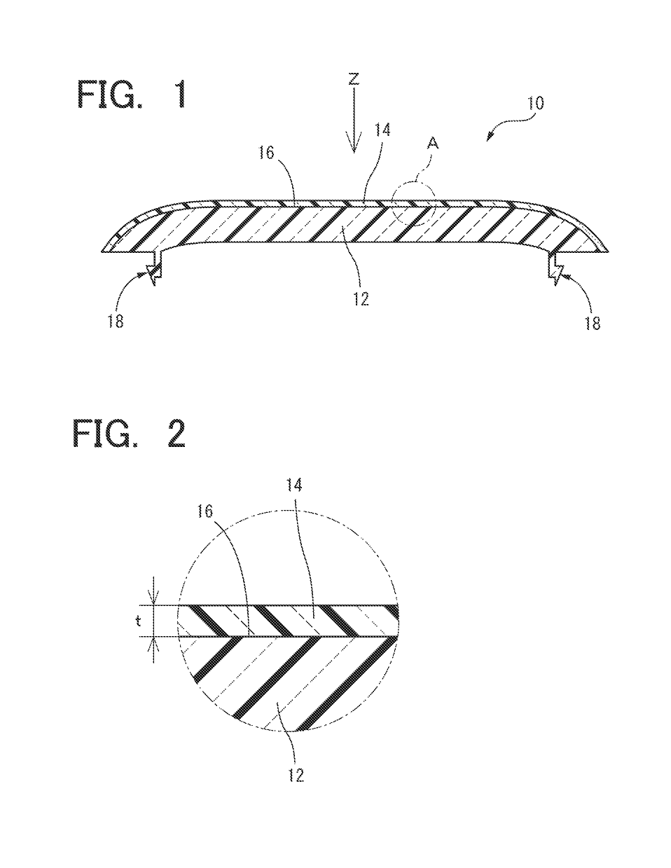

Referring to the cross sectional views of FIGS. 1 and 2, there is shown a formed ligneous body according to one embodiment of this invention, in the form of an automotive vehicle interior part or member 10. As is apparent from FIGS. 1 and 2, the automotive vehicle interior part 10 (hereinafter referred to simply as an “interior part 10”) takes the form of a generally elongate rectangular plate having a relatively large thickness and consisting of a ligneous substrate 12 and a clear layer 14 which are formed integrally with each other.

Described more specifically, the ligneous substrate 12 is a relatively thick portion which is the remainder of the interior part 10 other than the clear layer 14 provided on the side of a front surface of the interior part 10. The entirety of a surface (an upper surface as seen in FIG. 1) of the ligneous substrate 12 serves as a decorative design surface 16 which is curved and which presents a decorative design having an appearance of wood. As a material of the ligneous substrate 12, various kinds of lumber (timber) including high-grade lumbers such as a bird's eye maple and walnut may be used. In the present embodiment, the ligneous substrate 12 is formed from a less costly lumber such as an agathis. The ligneous substrate 12 is provided with a plurality of integrally formed fixing hooks 18 which project from a back surface and which are formed from the same material with the ligneous substrate 12. Each of these fixing hooks 18 has a known structure consisting of a flexible plate-like support portion, and a jaw portion formed integrally with the support portion so as to extend from the distal end of the support portion. The fixing hooks 18 are provided to fix the interior part 10 to a predetermined part of an automotive vehicle, with a single pressing action.

On the other hand, the clear layer 14 having a predetermined thickness (t) is formed integrally on the decorative design surface 16 of the ligneous substrate 12. The clear layer 14 has a high degree of translucency, and serves to protect the decorative design surface 16 from scratching or flawing and to give the decorative design surface 16 a glossy and deep appearance. The thickness (t) of the clear layer 14 is preferably held within a range of 400-600 μm. Where the thickness (t) is smaller than 400 μm, the clear layer 14 cannot sufficiently serve to give the glossy and deep appearance to the decorative design surface 16, giving rise to a problem of deterioration of decorative design of the interior part 10. On the other hand, where the thickness (t) is larger than 600 μm, there arises a risk of deterioration of the decorative design of the interior part 10 due to reduction of transparency of the clear layer 14 or whitening or yellowing of the clear layer 14. In this specific example, the clear layer 14 has the thickness (t) of about 500 μm.

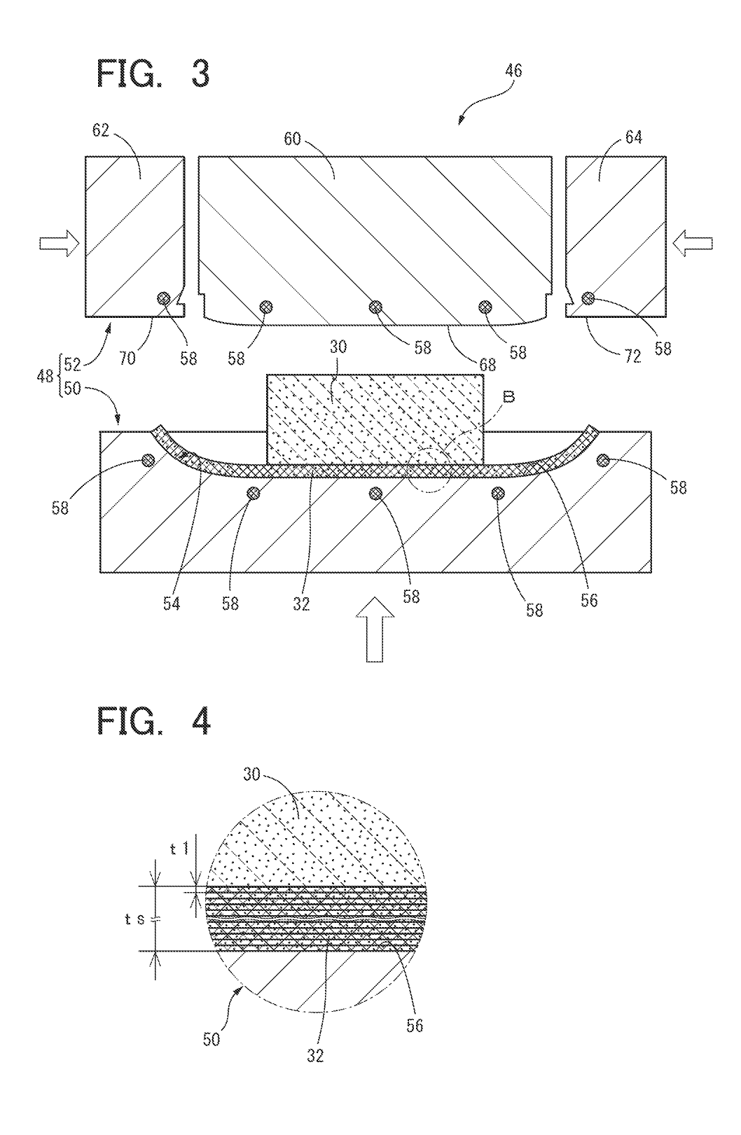

In the interior part 10 according to the present embodiment, the ligneous substrate 12 is formed by a flow molding process in which a resin-impregnated ligneous material 30 (shown in FIG. 3) impregnated with a suitable thermosetting resin material is formed into a desired shape, as described later. The walls of the fiber cells of the ligneous material of the ligneous substrate 12 are impregnated with the thermosetting resin material such as a melamine resin, and the thermosetting resin material is cured.

In the flow molding process, resin-impregnated paper sheets 32 (shown in FIG. 4) constituted by plant fibers and impregnated with a thermosetting resin material are heated and pressed together with the resin-impregnated ligneous material 30, whereby the resin-impregnated paper sheets 32 are made transparent and formed into the clear layer 14, as described later. Namely, the resin-impregnated paper sheets 32 constituting the clear layer 14 are impregnated with the thermosetting resin material such as the melamine resin, and the thermosetting resin material is cured, so that the clear layer 14 has the predetermined thickness (t) and a high degree of translucency.

Namely, in the present embodiment, the resin-impregnated paper sheets 32 are impregnated with the resin material (melamine resin), so that the resin material is contained in voids existing in the inside of the resin-impregnated paper sheets 32. In this respect, it is noted that a difference between a refractive index of the resin material and that of the plant fibers constituting the paper sheets 32 is smaller than a difference between the refractive index of the air and that of the plant fibers. Further, by heating and pressing operations during the flow molding process, the resin material is pressed further into the inside of the voids, and the voids are advantageously made smaller or disappeared by compression of the plant fibers. Accordingly, when a light is transmitted through the thus formed clear layer 14, reflection of the light within the clear layer 14 is advantageously reduced or prevented, whereby the clear layer 14 is effectively made transparent and advantageously given the high degree of translucency.

The interior part 10 having the structure described above is advantageously produced by the method which will be described.

Initially, a ligneous material and paper sheets each in the form of a non-woven cloth (which are sheet materials constituted by the plant fibers, and which will be hereinafter referred to simply as the “paper sheets”) are provided for respectively forming the ligneous substrate 12 and the clear layer 14 of the desired interior part 10.

In the present embodiment, the ligneous material used for forming the ligneous substrate 12 is a rectangular block cut from an agathis lumber in a direction perpendicular to the direction of extension of the fibers of the lumber. The ligneous material (the resin-impregnated ligneous material 30) has an outer profile (a flat area) which is smaller than that of the interior part 10 (an area of the decorative design surface 16), as shown in FIG. 3, for example. It is noted that the term “outer profile” used in the present embodiment is interpreted to mean a projection surface area of each member as seen in a direction perpendicular to its plane (as seen in the direction of an arrow Z in FIG. 1).

On the other hand, each of the paper sheets in the form of the non-woven cloth is obtained by forming the plant fibers (generally obtained by beating raw materials of paper, such as seed hair fibers, vascular bundle fibers, bast fibers, vein fibers and wood fibers) into a sheet, by a known method. For example, the paper sheet is obtained by papermaking using the plant fibers, or making the plant fibers combined (interwined) with each other by using physical or chemical means such as heat and a bonding agent, or mechanical means such as a high-pressure water flow. In the present embodiment, KimWipes (registered trademark; available from NIPPON PAPER CRECIA Co., LTD., Japan), which is a commercially available waste cloth made of paper or a paper sheet in the form of the non-woven cloth, is used as the paper sheet. The paper sheet has innumerable voids (spaces between the mutually interwined plant fibers) in its inside, and the reflection of a light is caused in those voids due to the difference between the refractive index of the plant fibers and that of the air. Therefore, the paper sheet generally does not have a high degree of translucency.

Then, the thus provided ligneous material and paper sheets are impregnated with the melamine resin used as the thermosetting resin material, by a conventional method. For instance, the ligneous material is immersed in an aqueous melamine resin solution accommodated in one of two immersion baths disposed within a suitable pressure vessel, and the paper sheets are immersed in other aqueous melamine resin solution which contains a light resistant agent used as an additive, and which is accommodated in the other of the two immersion baths. In such a state, a so-called “evacuating and pressurizing process” is practiced (as disclosed in JP-A-10-71607, for example) by reducing and raising the pressure within the pressure vessel to impregnate the ligneous material and the paper sheets with the respective aqueous solutions, whereby the walls of the fiber cells of the ligneous material, which fiber cells are principally composed of cellulose, are impregnated with one of the two aqueous melanine resin solutions, and the other aqueous melamine resin solution containing the light resistant agent is contained into the innumerable voids (among the plant fibers) in the inside of the paper sheets. In this respect, it is noted that a known curing accelerator is included in the respective aqueous melamine resin solutions, in a predetermined amount (about 0.5 part by weight per 100 parts by weight of the melamine resin), in order to advantageously cure the melamine resin in a subsequent step, and to reduce a required cycle time (a time required for a series of steps performed in production of the interior part 10).

While the molecular weight of the melamine resin in the aqueous melamine resin solutions accommodated in the respective immersion baths is not particularly limited, the average molecular weight of the melamine resin is preferably as small as not larger than about 2000. Where the average molecular weight of the melamine resin is larger than 2000, it is difficult to impregnate the fiber cell walls of the ligneous material with the melamine resin due to its excessively large molecular weight, so that there arises a risk of an excessively small amount of impregnation of the fiber cell walls of the ligneous material with the melamine resin, and a consequent insufficient effect of impregnation of the fiber cell walls of the ligneous material with the melamine resin.

While the concentrations of the aqueous melamine resin solutions accommodated in the respective immersion baths are not particularly limited, the concentrations are preferably within a range of about 10-50%, since the concentrations of the aqueous melamine resin solutions lower than 10% give rise to a risk of insufficiency of an amount of impregnation of the fiber cell walls of the ligneous material with the melamine resin, and insufficiency of an amount of the melamine resin contained in the voids of the paper sheets, resulting in consequent insufficient effects of impregnation of the ligneous material and the paper sheets with the melamine resin. On the other hand, the concentrations of the aqueous melamine resin solutions higher than 50% give rise to a risk of an excessively large amount of impregnation of the fiber cell walls of the ligneous material with the melamine resin, and an excessively large amount of the melamine resin contained in the voids of the paper sheets, resulting in a consequent excessive amount of increase of the weight of the interior part 10 to be obtained as the end product, and a risk of leakage of the melamine resin from the ligneous material and the paper sheets in a subsequent step (the heating and pressing operations), which may cause formation of burrs outside the desired outer profile of the end product.

Subsequently, the ligneous material impregnated with the aqueous melamine resin solution is taken out of the pressure vessel, and left in the atmosphere, or subjected to a blow of hot air, so that the ligneous material is dried, whereby the walls of the fiber cells of the ligneous material are advantageously impregnated with the aqueous melamine resin solution contained in those fiber cells.

As a result of impregnation of the fiber cell walls of the ligneous material with the aqueous melamine resin solution, the molecules of the melamine resin are adsorbed among molecular chains of the fiber cells (cellulose) of the ligneous material which are cross-linked by hydrogen bonds, so that the hydrogen bonds are cut. Namely, the present embodiment is configured such that a step of cutting the hydrogen bonds among the fiber cells of the ligneous material is implemented concurrently with a step of impregnating the fiber cell walls of the ligneous material with the melamine resin. Thus, the ligneous material impregnated with the thermosetting resin material is provided as the resin-impregnated ligneous material 30 to be used for forming the ligneous substrate 12.

On the other hand, the paper sheets impregnated with the aqueous melamine resin solution containing the light resistant agent are taken out of the pressure vessel, and dried, whereby the resin-impregnated paper sheets 32 (hereinafter simply referred to as the “paper sheets 32”) constituted by the plant fibers and impregnated with the thermosetting resin material are provided. In the present embodiment, the paper sheets 32 are further impregnated with the light resistant agent used as the additive.

Then, the resin-impregnated ligneous material 30 is subjected to the flow molding process, and the paper sheets 32 are subjected to the heating and pressing operations, by using a heating and pressing device 46, as shown in FIGS. 3-8.

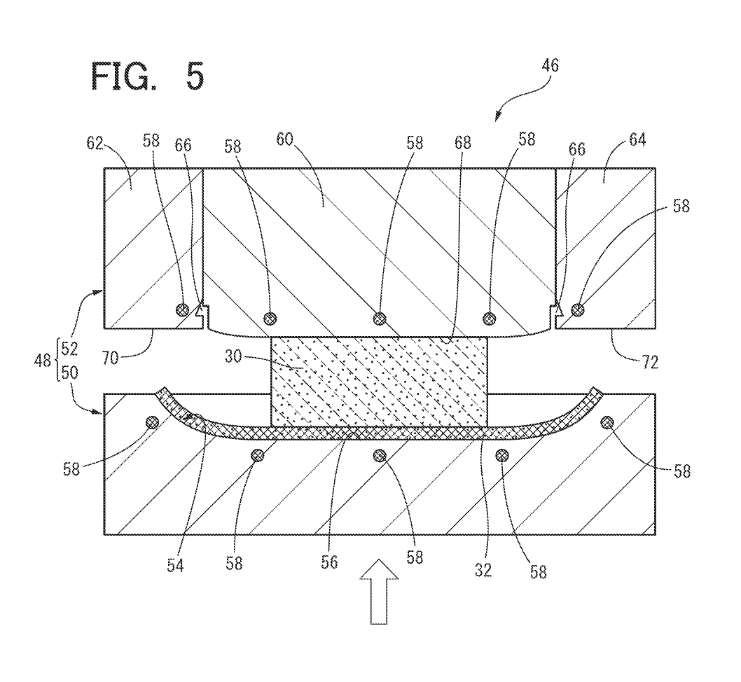

As is apparent from FIGS. 3 and 5, for example, the heating and pressing device 46 used in the present embodiment has a forming mold 48. This forming mold 48 includes a lower die 50 and an upper die 52 which is disposed above and in opposition to the lower die 50 with a predetermined distance therebetween.

The lower die 50 of the forming mold 48 is movable in the vertical direction by a predetermined distance, by a moving device (not shown) which includes a hydraulic cylinder or the like and which has a structure known in the art. The lower die 50 has a recess 54 open in its upper surface. This recess 54 has an inner surface of a generally elongate rectangular shape, which serves as a downwardly curved cavity surface 56 which corresponds to the front surface of the interior part 10. Further, the lower die 50 has a plurality of cartridge heaters 58 embedded therein in the vicinity of the cavity surface 56. These cartridge heaters 58 are controlled of their heating temperature, by a controller not shown, so that the cavity surface 56 is heated to a predetermined temperature by the cartridge heaters 58 under the control of the controller.

On the other hand, the upper die 52 includes a first split-die member 60 disposed in its central part, and a second split-die member 62 and a third split-die member 64 which are disposed on respective opposite sides of the recess 54 in the longitudinal direction (the right to left direction as seen in FIGS. 3 and 5) of the recess 54, such that the first split-die member 60 is interposed between the second and third split-die members 62 and 64. In the present embodiment, the first split-die member 60 is fixed in position, and the second and third split-die members 62 and 64 are movable toward and away from the first split-die member 60, by hydraulic cylinders or any other known moving devices not shown. Movements of the second and third split-die members 62 and 64 toward the first split-die member 60 cause abutting contact of the first, second and third split-die members 60, 62 and 64 with each other on their mutually opposed surfaces. These opposed surfaces of the first, second and third split-die members 60, 62 and 64 in abutting contact with each other define fixing-hook forming cavities 66 which are open downwards, and which are provided to form the above-described fixing hooks 18 integrally with the back surface of the ligneous substrate 12 (the interior part 10).

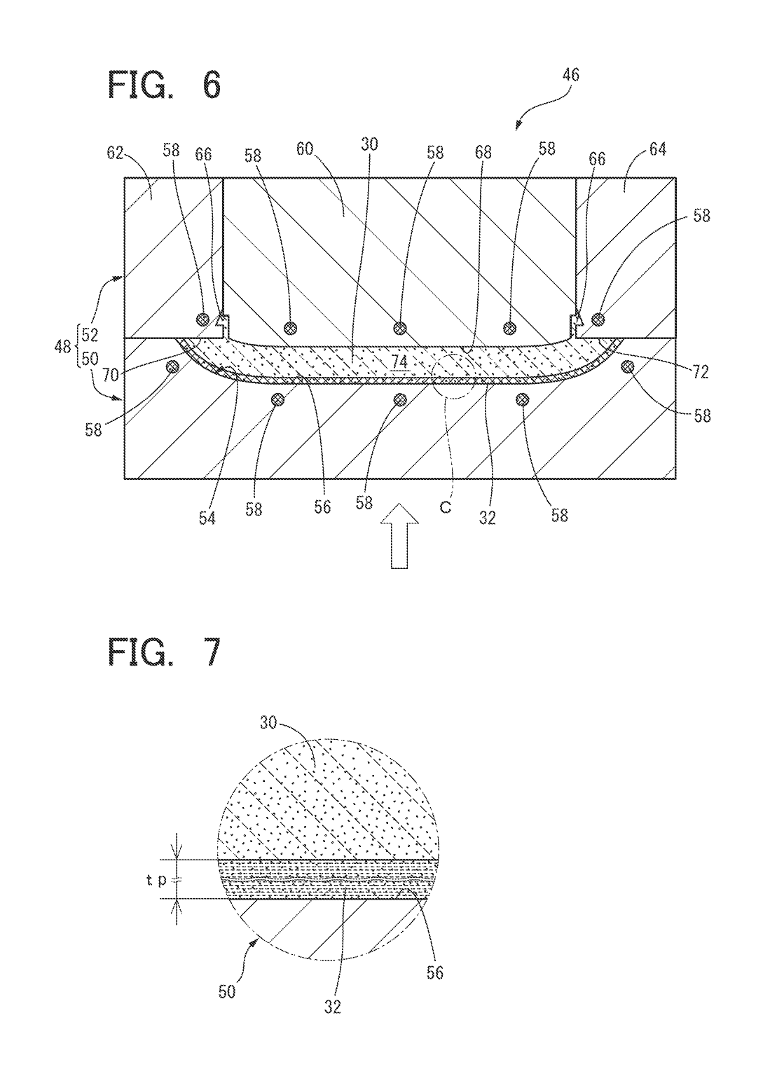

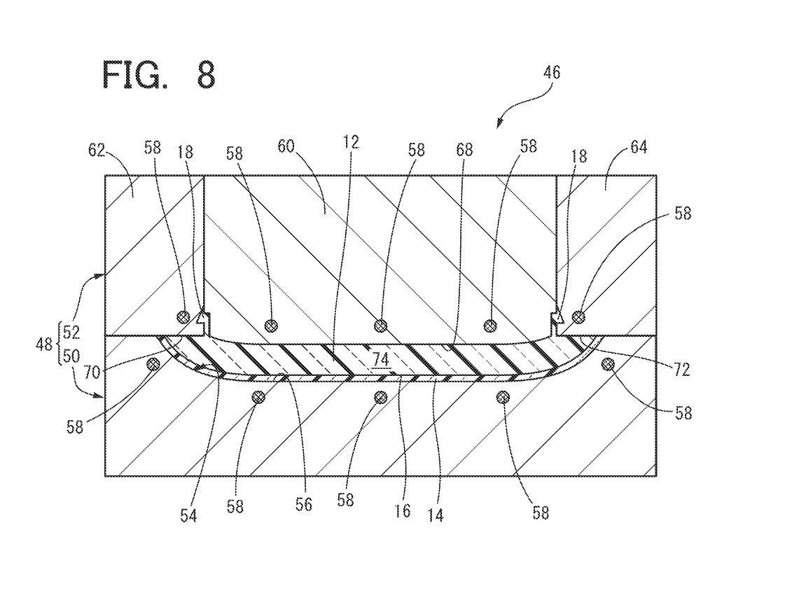

The first split-die member 60 has a curved lower surface which functions as a first pressure surface 68, while the second and third split-die members 62 and 64 have respective flat lower surfaces which function as respective second and third pressure surfaces 70 and 72. In the present embodiment, the cavity surface 56 of the lower die 50 and the first, second and third pressure surfaces 68, 70 and 72 of the upper die 52 (the split-die members 60, 62 and 64) cooperate to define a forming cavity 74 for forming the intended formed article, as shown in FIGS. 6 and 8. Each of the split-die members 60, 62 and 64 has a plurality of cartridge heaters 58 or one cartridge heater 58 embedded therein in the vicinity of the pressure surfaces 68, 70 and 72. Like the cartridge heaters 58 embedded in the lower die 50, the cartridge heaters 58 of the upper die 52 are controlled of their heating temperatures, by the controller not shown, so that the pressure surfaces 68, 70 and 72 are heated to predetermined temperatures by the cartridge heaters 58 under the control of the controller.

To perform the flow molding process with respect to the resin-impregnated ligneous material 30, and the heating and pressing operations with respect to the paper sheets 32, by using the heating and pressing device 46 having the thus constructed forming mold 48, the paper sheets 32 and the resin-impregnated ligneous material 30 are accommodated in the recess 54 of the lower die 50, such that the paper sheets 32 and the resin-impregnated ligneous material 30 are superposed on each other, while the upper die 52 and the lower die 50 are vertically spaced apart from each other, as shown in FIG. 3.

In this respect, it is noted that each of the paper sheets 32 has an outer profile of substantially the same size as the cavity surface 56 (interior part 10), and the plurality of paper sheets 32 are superposed on each other and used to form the clear layer 14 with the predetermined thickness (t). In the present embodiment, 30 paper sheets 32 each having a thickness (t1) of about 0.1 mm (100 μm) are superposed on each other as shown in FIG. 4, so that the thus formed stack of the paper sheets 32 has a thickness (ts) of about 3 mm. In order to obtain the desired thickness (t) of the clear layer 14, the stack of the paper sheets 32 preferably has the thickness (ts) of about 2-4 mm, before the paper sheets 32 are subjected to the heating and pressing operations.

After or before the resin-impregnated ligneous material 30 and the paper sheets 32 are accommodated within the recess 54 as described above, the cavity surface 56 of the lower die 50 is heated by the plurality of cartridge heaters 58 embedded in the lower die 50, to the curing point of the melamine resin contained in the fiber cell walls of the resin-impregnated ligneous material 30 and the paper sheets 32, and the cavity surface 56 is kept at this temperature. On the other hand, the first, second and third pressure surfaces 68, 70 and 72 of the first, second and third split-die members 60, 62 and 64 of the upper die 52 are also heated by the cartridge heaters 58 embedded in the split-die members 60, 62 and 64, to the curing point of the melamine resin, and kept at this temperature. Described more specifically, the cavity surface 56 and the first, second and third pressure surfaces 68, 70 and 72 are heated to and kept at a temperature of about 150° C. Although the optimum heating temperatures of the cavity surface 56 and the first, second and third pressure surfaces 68, 70 and 72 are influenced by the curing point and the melting point of the resin material used to impregnate the ligneous material 30 and the paper sheets 32, the optimum temperatures are generally selected within a range of about 100-200° C.

Then, as shown in FIG. 5, the second and third split-die members 62 and 64 are moved into abutting contact with the first split-die member 60, so that these three split-die members 60, 62 and 64 cooperate to form the upper die 52, and at the same time, the lower die 50 is moved upwards, whereby the resin-impregnated ligneous material 30 and the paper sheets 32 are pressed or compressed by the first, second and third pressure surfaces 68, 70 and 72 in the direction of mutual superposition of the ligneous material 30 and the paper sheets 32.

During the above-described movements of the second and third split-die members 62 and 64 and the lower die 50, a lower portion of the resin-impregnated ligneous material 30 opposed to the cavity surface 56 via the paper sheets 32 is heated by the heat of the cavity surface 56, and an upper portion of the resin-impregnated ligneous material 30 is heated by the first pressure surface 68 of the first split-die member 60 of the upper die 52, whereby the resin-impregnated ligneous material 30 as a whole is softened.

Subsequently, the lower die 50 is further moved upwards from the position of FIG. 5, to perform the heating and pressing operations with respect to the resin-impregnated ligneous material 30 and the paper sheets 32. At this time, the entirety of the resin-impregnated ligneous material 30 has already been softened, so that the resin-impregnated ligneous material 30 is pressed onto the cavity surface 56 by the upper die 52, and is thereby gradually shaped so as to follow the shapes of the cavity surface 56 and the pressure surfaces 68, 70 and 72.

It is noted that the hydrogen bonds among the fiber cells of the resin-impregnated ligneous material 30 have been cut as a result of impregnation of the fiber cell walls with the melamine resin, so that the resin-impregnated ligneous material 30 is subjected to the flow molding process during the above-described heating and pressing operations performed on the resin-impregnated ligneous material 30, until the melamine resin contained in the resin-impregnated ligneous material 30 has been completely cured. Namely, shearing forces act on the fiber cells of the resin-impregnated ligneous material 30 during the heating and pressing operations on the resin-impregnated ligneous material 30, so that relative positions of the fiber cells are changed, and the resin-impregnated ligneous material 30 flows along the pressure surfaces 68, 70 and 72, and the cavity surface 56, via the paper sheets 32. In this respect, it is noted that the resin-impregnated ligneous material 30 is generally pressed in the flow molding process, with a pressure sufficient to permit the resin-impregnated ligneous material 30 to have a specific gravity of not less than 1.3.

In the flow molding process performed with respect to the resin-impregnated ligneous material 30, the paper sheets 32 are pressed onto the cavity surface 56, while an upper surface of the uppermost one of the paper sheets 32 is covered with a lower surface of the resin-impregnated ligneous material 30 being deformed in the flow molding process. In other words, the paper sheets 32 are subjected to the heating and pressing operations, in such a state wherein the paper sheets 32 are interposed between the pressure surfaces 68, 70 and 72, and the cavity surface 56, via the resin-impregnated ligneous material 30 being deformed in the flow molding process. At this time, the melamine resin (the thermosetting resin material) and the light resistant agent (the additive) contained in the paper sheets 32 are held within the paper sheets 32 (among the plant fibers), so that it is possible to advantageously reduce or prevent a risk of an excessively large amount of flow of the melamine resin and the light resistant agent and a risk of leakage of the melamine resin and the light resistant agent from the forming cavity 74 (the recess 54).

Subsequently, the lower die 50 is further moved upwards to a position at which the forming cavity 74 is formed between the lower die 50 and the upper die 52, as shown in FIG. 6, to perform the flow molding process with respect to the resin-impregnated ligneous material 30.

That is, the heating and pressing operations are performed on the resin-impregnated ligneous material 30 which has been impregnated with the melamine resin to cut the hydrogen bonds, so that the shearing forces act on the fiber cells of the resin-impregnated ligneous material 30, and the relative positions of the fiber cells are changed. As a result, the resin-impregnated ligneous material 30 flows within the forming cavity 74 formed between the upper die 52 and the lower die 50, and the forming cavity 74 and the fixing-hook forming cavities 66 are filled with the resin-impregnated ligneous material 30. In the present embodiment, the resin-impregnated ligneous material 30 is the rectangular block cut from the lumber in the direction perpendicular to the direction of extension of the fibers of the lumber, so that the resin-impregnated ligneous material 30 flows in the direction perpendicular to the direction of extension of the fibers. Accordingly, the resin-impregnated ligneous material 30 flows smoothly by a sufficiently large amount. Namely, the resin-impregnated ligneous material 30 flows freely within the forming cavity 74 by the sufficiently large amount, during the flow molding process.

Under the state wherein the forming cavity 74 and the fixing-hook forming cavities 66 are filled with the resin-impregnated ligneous material 30, the resin-impregnated ligneous material 30 and the paper sheets 32 are kept subjected to the pressing force, so that the resin-impregnated ligneous material 30 and the paper sheets 32 are compacted. Namely, the resin-impregnated ligneous material 30 and the paper sheets 32 are concurrently pressed with a force of about 100 t, between the first, second and third pressure surfaces 68, 70 and 72 of the upper die 52 (the first, second and third split-die members 60, 62 and 64) and the cavity surface 56 of the lower die 50, in the direction of mutual superposition of the ligneous material 30 and the paper sheets 32.

By the series of heating and pressing operations performed on the paper sheets 32 during the flow molding process performed on the resin-impregnated ligneous material 30, the melamine resin contained in the voids within the paper sheets 32 is pressed further into the inside of the paper sheets 32 to completely fill the voids, and the paper sheets 32 are compacted (see FIG. 7; tp<ts) so that the voids are made smaller or disappeared.

The resin-impregnated ligneous material 30 and the paper sheets 32 which are compacted (compressed) as described above are heated to the curing point of the melamine resin, by the first, second and third pressure surfaces 68, 70 and 72 and the cavity surface 56, which are heated by the cartridge heaters 58. In the present embodiment, the resin-impregnated ligneous material 30 and the paper sheets 32 are kept heated and pressed by the upper and lower dies 50 and 52 for about five minutes (after the upper and lower dies 50 and 52 are closed), for example.

Thus, as shown in FIG. 8, the resin-impregnated ligneous material 30 is given (formed by the flow molding process to have) a permanent shape corresponding to a portion of the forming cavity 74 other than the portion in which the clear layer 14 (the paper sheets 32) is disposed, whereby the ligneous substrate 12 is eventually formed. At the same time, the paper sheets 32 are pressed onto the cavity surface 56 of the forming cavity 74 and compacted (heated and pressed), so that the paper sheets 32 are given a permanent shape and made transparent, whereby the clear layer 14 is eventually formed with the predetermined thickness. Thus, the ligneous substrate 12 and the clear layer 14 are integrated into a one-piece body in the forming cavity 74. It is considered that the ligneous substrate 12 and the clear layer 14 are advantageously integrated into the one-piece body, owing to the fact that the melamine resin contained in the ligneous substrate 12 (the resin-impregnated ligneous material 30) and the melamine resin contained in the clear layer 14 (the paper sheets 32) are chemically combined with each other (polymerized or mixed together since these melamine resins are the same thermosetting resin material), and bonded to each other. It is noted that a surface of the ligneous substrate 12 on the side of the cavity surface 56 (which surface is in contact with the clear layer 14) serves as the decorative design surface 16.

Then, the upper die 52 and the lower die 50 are spaced apart from each other, and the one-piece body consisting of the ligneous substrate 12 and the clear layer 14 is removed from the upper die 52 and the lower die 50. Thus, the interior part 10 having the structure shown in FIG. 1 is produced.

It will be understood from the foregoing description that in the interior part 10 according to the present embodiment, the clear layer 14 having translucency and integrally formed on the decorative design surface 16 of the ligneous substrate 12 has the predetermined thickness (t), so that the interior part 10 gives a deep and excellent appearance of the decorative design on the side of its front surface.

Namely, the clear layer 14 is formed by heating and pressing the plurality of resin-impregnated paper sheets 32 superposed on each other, so that the melamine resin contained in the paper sheets 32 is held within the paper sheets 32, in other words, held among the plant fibers constituting the paper sheets 32. Therefore, upon application of a pressing force on the paper sheets 32 during the flow molding process, an excessively large amount of flow of the melamine resin and leakage of the melamine resin from the forming cavity 74 are advantageously prevented, to assure the desired thickness of the clear layer 14, whereby the decorative design surface 16 is advantageously given a glossy and deep appearance. The interior part 10 according to the present embodiment has a further advantage in that strength of a portion of the interior part 10 on the side of its front surface is advantageously improved by a reinforcing effect of the plant fibers constituting the paper sheets 32.

Further, in the present embodiment, the translucency of the clear layer 14 is advantageously improved, presumably for the reasons described below. The resin-impregnated paper sheets 32 (the paper sheets in the form of the non-woven cloths) originally have a low degree of translucency, as described above. However, the resin material (the melamine resin) whose refractive index is closer to that of the plant fibers than the air is contained in the voids existing in the inside of the paper sheets 32. Further, by the heating and pressing operations, the resin material is pressed into the inside of the voids, and the voids are advantageously made smaller or disappeared by compression of the plant fibers. Accordingly, when a light is transmitted through the formed clear layer 14, reflection of the light within the clear layer 14 is advantageously reduced or prevented, whereby the clear layer 14 is advantageously given the high degree of translucency. Therefore, even though the clear layer 14 has the predetermined thickness, the decorative design surface 16 having the appearance of wood can be clearly seen on the side of the front surface of the interior part 10.

In the present embodiment, the flow molding process with respect to the resin-impregnated ligneous material 30 and the heating and pressing operations with respect to the paper sheets 32 are concurrently performed within the forming cavity 74, so that the number of steps required for production of the interior part 10 can be reduced to advantageously reduce the production cost of the interior part 10.

Further, while the resin-impregnated ligneous material 30 and the paper sheets 32 are heated and pressed, the thermosetting resin materials (the melamine resin) contained in the ligneous material 30 and the paper sheets 32 are cured or solidified, so that the ligneous substrate 12 and the clear layer 14 are formed integrally with each other and effectively integrated into the one-piece body within the forming cavity 74.

Namely, the resin-impregnated ligneous material 30 and the paper sheets 32 are bonded to each other under pressure. Further, the resin materials respectively contained in the resin-impregnated ligneous material 30 and the paper sheets 32 are the same thermosetting resin material, so that these resin materials are mixed together or chemically combined with each other, whereby adhesiveness between the ligneous substrate 12 and the clear layer 14 is improved to advantageously prevent cracking and peeling of the clear layer 14 from the ligneous substrate 12. The adhesiveness between the ligneous substrate 12 and the clear layer 14 is further improved in the present embodiment, since the resin-impregnated ligneous material 30 and the paper sheets 32 are impregnated with the same kind of thermosetting resin material (the melamine resin).

Further, in the present embodiment, the paper sheets 32 further contain the light resistant agent used as the additive, together with the melamine resin, so that the formed clear layer 14 contains the light resistant agent. In this respect, it is noted that the effect of the light resistant agent can be achieved in the case where the light resistant agent exists in the portion of the interior part 10 (formed ligneous body) on the side of its front surface. According to the method of producing the interior part 10 of the present embodiment, the light resistant agent can be selectively added only to the clear layer 14 constituting the portion of the interior part 10 on the side of its front surface. Accordingly, an amount of use of the relatively costly light resistant agent can be efficiently reduced, while sufficiently achieving the effect of the light resistant agent, to advantageously reduce the production cost of the interior part 10.

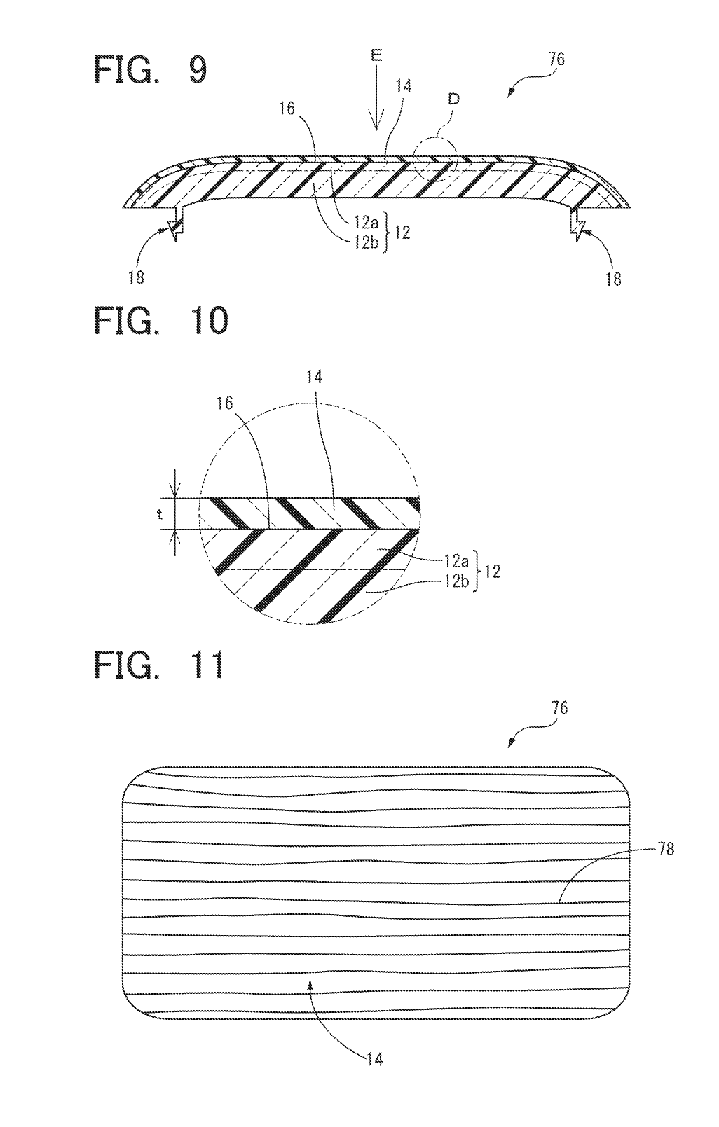

A formed ligneous body (an interior part 76) having a structure according to another embodiment of the present invention is shown in FIGS. 9-14. The same reference signs as used in the above-described embodiment will be used in the present embodiment to identify the elements and portions having the same structures, and those elements and portions will not be described redundantly. Further, the same processes and operations as those performed in the above-described embodiment are performed in the present embodiment unless otherwise specified, and such processes and operations will not be described redundantly.

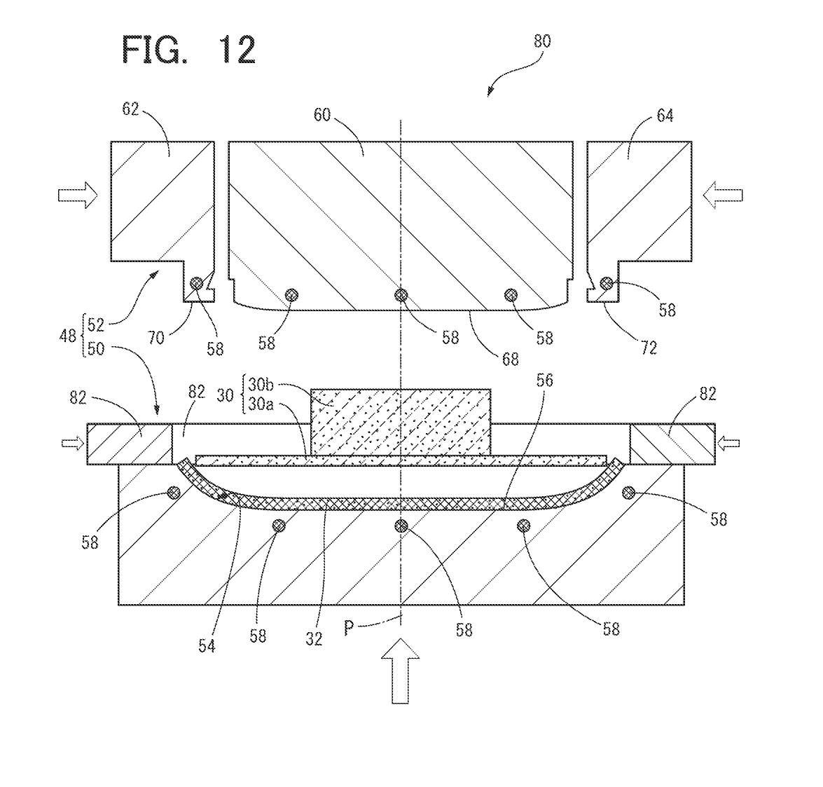

As shown in FIGS. 9 and 10, the ligneous substrate 12 of the interior part 76 according to the present embodiment consists of a sliced veneer layer 12a constituting a front portion of the ligneous substrate 12 on the side of the clear layer 14, and a substrate layer 12b formed on the backside of the sliced veneer layer 12a. A surface of the sliced veneer layer 12a on the side of the clear layer 14 serves as the decorative design surface 16 on which a woody grain pattern 78 of the sliced veneer layer 12a is presented, as shown in FIG. 11.

The interior part 76 having the structure described above can be advantageously produced by the method which will be described.

Initially, a sliced veneer and a substrate-layer forming block are provided as ligneous materials for forming the ligneous substrate 12 of the desired interior part 76. The sliced veneer is a thin elongate rectangular flat sheet sliced from a bird's-eye maple lumber, which is a high-grade lumber having a fine woody grain, in a direction parallel to the direction of extension of the fibers of the lumber, while the substrate-layer forming block is a rectangular block which is cut from an agathis lumber and similar to that used in the above-described embodiment. Further, paper sheets each in the form of a non-woven cloth, which are similar to those used in the above-described embodiment are provided for forming the clear layer 14.

The thus provided sliced veneer, substrate-layer forming block and paper sheets are impregnated with the melamine resin which is the thermosetting resin material, by a method similar to that practiced in the above-described embodiment, whereby a resin-impregnated sliced veneer sheet 30a, a resin-impregnated substrate-layer forming block 30b (hereinafter simply referred to as a “resin-impregnated block 30b”) and paper sheets 32 are provided.

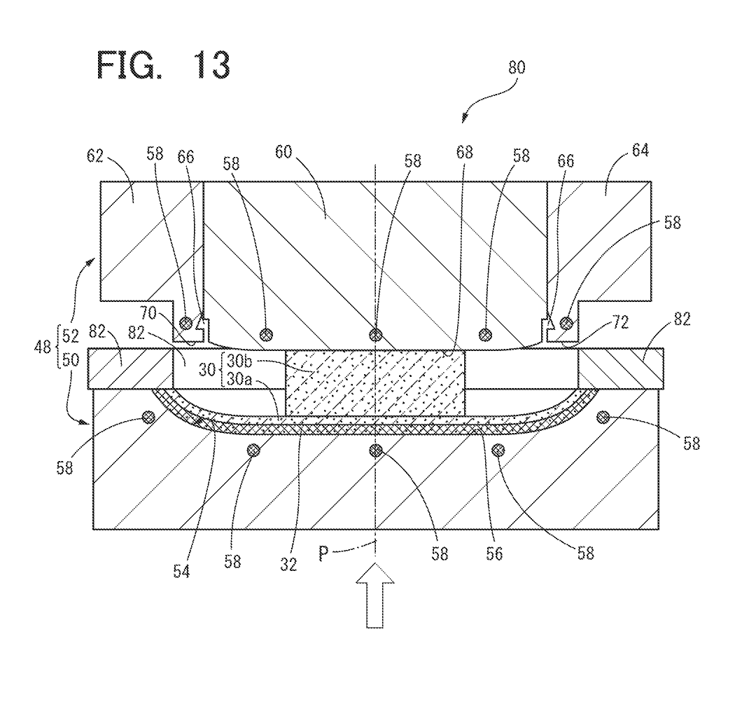

Then, the resin-impregnated sliced veneer sheet 30a and the resin-impregnated block 30b are subjected to a flow molding process, and the paper sheets 32 are subjected to heating and pressing operations, by using a heating and pressing device 80, as shown in FIGS. 12-14.

As shown in FIG. 12, for example, the structure of the heating and pressing device 80 used in the present embodiment is substantially the same as that of the heating and pressing device 46 used in the above-described embodiment, except the structure of the lower die 50. Namely, four deformation preventive portions 82 (three of which are shown in FIGS. 12-14) are disposed on the upper surface of the lower die 50 of the heating and pressing device 80.

To perform the flow molding process with respect to the resin-impregnated sliced veneer sheet 30a and the resin-impregnated block 30b, and the heating and pressing operations with respect to the paper sheets 32, by using the heating and pressing device 80 having the structure described above, the paper sheets 32, the resin-impregnated sliced veneer sheet 30a and the resin-impregnated block 30b are set with respect to the recess 54 of the lower die 50, such that the paper sheets 32, the resin-impregnated sliced veneer sheet 30a and the resin-impregnated block 30b are superposed on each other, as shown in FIG. 12, while the upper die 52 and the lower die 50 are vertically spaced apart from each other, with the four deformation preventive portions 82 being located at respective positions (retracted positions) spaced apart form a center axis P of the lower die 50 in radially outward directions.

Then, the four deformation preventive portions 82 are moved toward the center axis P of the lower die 50 in radially inward directions, to respective positions (advanced positions), for abutting contact with each other in the circumferential direction, as shown in FIG. 13. Further, the lower die 50 is moved upwards, whereby the resin-impregnated sliced veneer sheet 30a, the resin-impregnated block 30b and the paper sheets 32 are heated and pressed by the first, second and third pressure surfaces 68, 70 and 72, in the direction of mutual superposition of the sliced veneer sheet 30a, the block 30b and the paper sheets 32.

The lower die 50 is further moved upwards from the position of FIG. 13, so that the resin-impregnated sliced veneer sheet 30a and the resin-impregnated block 30b are subjected to the flow molding process.

At this time, the entirety of the resin-impregnated sliced veneer sheet 30a has already been softened by heating, and the hydrogen bonds among the fiber cells of the rein-impregnated sliced veneer sheet 30a have been cut as a result of impregnation of the fiber cell walls with the melamine resin, as in the case of the resin-impregnated ligneous material 30 of the above-described embodiment. Therefore, the resin-impregnated sliced veneer sheet 30a flows along the cavity surface 56 by the heating and pressing operations described above.

However, the rein-impregnated sliced veneer sheet 30a is subjected to the heating and pressing operations (the flow molding process) while the inner circumference of a ring constituted by the four deformation preventive portions 82 positioned at the respective advanced positions is located radially inwardly with respect to the periphery of the opening of the recess 54. Accordingly, the resin-impregnated sliced veneer sheet 30a flowing along the cavity surface 56 is advantageously prevented from leaking from or running out of the recess 54.

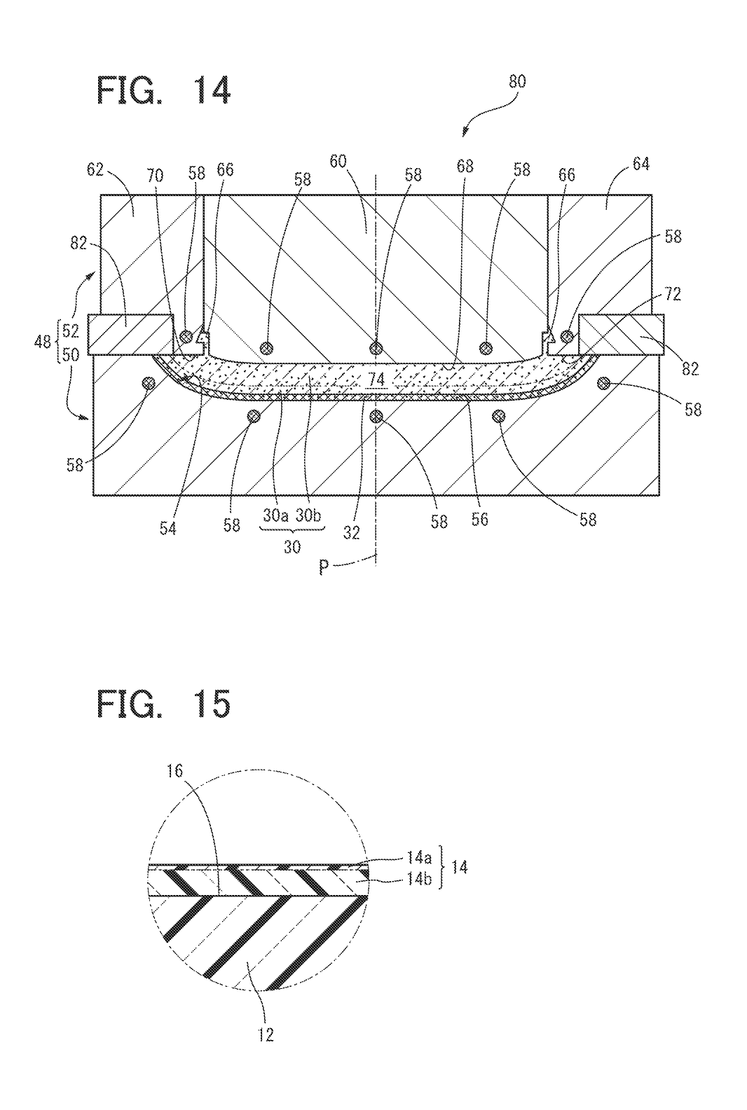

Subsequently, the lower die 50 is further moved upwards to a position at which the forming cavity 74 is formed between the upper die 52 and the lower die 50, as shown in FIG. 14. As a result, the compacted (compressed) resin-impregnated sliced veneer sheet 30a, resin-impregnated block 30b and paper sheets 32 are heated to the curing point of the melamine resin, by the heated first, second and third pressure surfaces 68, 70 and 72 and the heated cavity surface 56.

Thus, the resin-impregnated sliced veneer sheet 30a and the resin-impregnated block 30b are given (formed by the flow molding process to have) respective predetermined permanent shapes, whereby the ligneous substrate 12 consisting of the sliced veneer layer 12a and the substrate layer 12b is eventually formed. At the same time, the clear layer 14 is formed with the predetermined thickness. Thus, the ligneous substrate 12 and the clear layer 14 are formed integrally with each other in the forming cavity 74, whereby the interior part 76 having the structure shown in FIG. 9 is obtained.

It will be understood from the foregoing description that the method according to the present embodiment permits advantageous production of the interior part 76 having the excellent properties, like the interior part 10 described above.

In the present embodiment, the sliced veneer layer 12a is formed from the high-grade lumber having the fine woody grain in the front portion of the ligneous substrate 12 on the side of the clear layer 14, and the woody grain pattern 78 of the sliced veneer layer 12a is presented on the decorative design surface 16. Therefore, an excellent decorative design giving a more realistic ligneous appearance can be realized according to the method of the present embodiment. Further, in formation of the sliced veneer layer 12a, the resin-impregnated sliced veneer sheet 30a is prevented from flowing by an excessively large amount, by the deformation preventive portions 82. Therefore, deformation of the woody grain pattern 78 can be advantageously reduced or prevented, so that the original fine woody grain of the lumber (the sliced veneer) used for forming the sliced veneer layer 12a is presented on the decorative design surface 16 without aesthetical deterioration.

In formation of the clear layer 14, the resin-impregnated paper sheets 32 used for forming the clear layer 14 are heated and pressed within a space of the forming cavity 74, which space is defined by the cavity surface 56, the resin-impregnated sliced veneer sheet 30a and the deformation preventive portions 82, and the thermosetting resin material contained in the resin-impregnated paper sheets 32 is cured in such a state. Therefore, an extremely large amount of flow of the thermosetting resin material and leakage of the thermosetting resin material from the forming cavity 74 (the recess 54) are more advantageously reduced or prevented, to more stably assure the desired thickness of the clear layer 14.

While the embodiments of this invention have been described above for illustrative purpose only, it is to be understood that the invention is not limited to the details of the illustrated embodiments.

For example, a transparent resin layer 14a may be formed from the thermosetting resin material oozing from the resin-impregnated paper sheets 32, in a part or an entirety of an exposed surface area of the clear layer 14, as shown in FIG. 15. Namely, in formation of the clear layer 14 shown in FIG. 15, a portion of the thermosetting resin material contained in the resin-impregnated paper sheets 32 oozes from the paper sheets 32 on the side of the exposed surface of the clear layer 14 to be formed (on the side of the cavity surface 56), by the heating and pressing operations, and is cured in such a state, whereby the transparent resin layer 14a is formed, so that the formed clear layer 14 consists of the transparent resin layer 14a and a layer 14b in which the non-woven cloths constituting the resin-impregnated paper sheets 32 are present.

In the above-described second embodiment in which the front portion of the ligneous substrate 12 on the side of the clear layer 14 is constituted by the sliced veneer layer 12a, the sliced veneer or the resin-impregnated sliced veneer sheet 30a used for forming the sliced veneer layer 12a may be subjected to a forming operation using a forming mold other than the forming mold described above, in advance of the above-described flow molding process and heating and pressing operations. This method permits an improvement of the decorative design by allowing the sliced veneer layer 12a to advantageously retain the woody grain of the sliced veneer, and advantageous formation of the clear layer 14 by preventing the paper sheets 32 from flowing in the subsequent step. In the case where the resin-impregnated sliced veneer sheet 30a is heated during the forming operation, the resin-impregnated sliced veneer sheet 30a is preferably heated such that the thermosetting resin material contained in the sliced veneer sheet 30a is not completely cured, in order to advantageously improve adhesiveness of the sliced veneer layer 12a with respect to the clear layer 14 and the substrate layer 12b.

Further, additives other than the light resistant agent used in the above-described embodiments may be added to the clear layer 14. Examples of the additives include a coloring agent, an ultraviolet-absorbing agent, a heat-absorbing agent and an anti-oxidizing agent, which additives exhibit their effects in the case where they exist in the portion (the clear layer 14) of the interior part 10 (the formed ligneous body) on the side of its front surface. Any one or any combination of the above-indicated additives may be used. By adding the above-indicated additives to the aqueous melamine resin solution, and impregnating the paper sheets in the form of the non-woven cloths with the thus obtained aqueous melamine resin solution (containing the additives), as in the above-described embodiments, the additives can be selectively added to the clear layer 14, to efficiently reduce amounts of use of the relatively costly additives, and advantageously reduce the production cost of the intended formed ligneous body.

The paper sheets may be impregnated with the additives by a known process before the paper sheets are impregnated with the melamine resin. Alternatively, the paper sheets may be initially impregnated with the melamine resin, and the thus obtained resin-impregnated paper sheets 32 may be impregnated with the additives by a known process. However, it is preferable to immerse the paper sheets in the aqueous melamine resin solution containing the additives, such that the additives are introduced into the paper sheets together with the melamine resin, from the viewpoints of effectively impregnating the paper sheets with the additives, and eliminating a need to perform an extra process for impregnating the paper sheets with the additives, to reduce the production cost of the intended formed ligneous body.

In the above-described embodiments, the ligneous material (or the sliced veneer and the substrate-layer forming block) and the paper sheets in the form of the non-woven cloths are impregnated with the melamine resin (the respective aqueous melamine resin solutions) in the respective separate immersion baths. However, particularly in the case where there is no need to impregnate the paper sheets with the additives, it is possible to immerse the ligneous material (or the sliced veneer and the substrate-layer forming block) and the paper sheets in the same aqueous melamine resin solution accommodated in a single immersion bath placed in the pressure vessel, to impregnate the ligneous material (or the sliced veneer and the substrate-layer forming block) and the paper sheets with the aqueous solution. This makes it possible to simplify the facility used for the impregnation operation.

In the above-described embodiments, the impregnation operation for impregnating the paper sheets with the melamine resin is performed by the evacuating and pressurizing process, in the same manner as (concurrently with) the impregnation operation for impregnating the ligneous material with the melamine resin. However, the paper sheets can be more easily impregnated with the melamine resin, than the ligneous material, by a process other than the evacuating and pressurizing process. For example, the paper sheets may be impregnated with the melamine resin by a so-called dipping process in which the paper sheets are immersed in the aqueous melamine resin solution (containing the additives) at an ordinary temperature under an ordinary pressure.

The thermosetting resin material with which the ligneous material and the paper sheets are impregnated may be any known resin material such as a urea resin and a phenolic resin, other than the melamine resin used in the above-described embodiments. According to the present invention, it is preferable to use resin materials such as the melamine resin and the urea resin which are transparent or which have a sufficiently high degree of translucency and can be considered substantially transparent. Further, the thermosetting resin material with which the ligneous material and the paper sheets are impregnated may be colored by adding a dye, a pigment or the like to the thermosetting resin material, as long as translucency of the resin material is not considerably deteriorated by the addition of the dye, pigment or the like.

In the above-described embodiments, the resin-impregnated ligneous material 30 (or the resin-impregnated sliced veneer sheet 30a and the resin-impregnated block 30b) and the paper sheets 32 are impregnated with the same kind of thermosetting resin material in the form of the melamine resin. However, the resin-impregnated ligneous material 30 (or the resin-impregnated sliced veneer sheet 30a and the resin-impregnated block 30b) and the paper sheets 32 may be impregnated with respective different kinds of resin materials. In order to advantageously improve adhesiveness between the ligneous substrate 12 and the clear layer 14, the resin-impregnated ligneous material 30 (or the resin-impregnated sliced veneer sheet 30a and the resin-impregnated block 30b) and the paper sheets 32 are preferably impregnated with the same kind of resin material or a combination of resin materials such as the melamine resin and the urea resin, which can be chemically combined with each other.

The ligneous material and the paper sheets may be impregnated with the thermosetting resin material, by any known method. For instance, the ligneous material and the paper sheets may be coated with an aqueous solution of the resin material, by using a sponge-roll coater, a natural reverse coater, a flow coater or the like, so that the ligneous material and the paper sheets are impregnated with the resin material.

In the above-described embodiments, the plurality of paper sheets 32 superposed on each other are used to assure the thickness (t) of the clear layer 14. However, the clear layer 14 may be formed by using a paper sheet having a sufficiently large surface area and folded so as to have the predetermined thickness, or a paper sheet having a sufficiently large thickness.

The directions (with respect to the direction of extension of the fibers of the lumbers) in which the ligneous materials (including the sliced veneer) are sliced from the lumbers are not limited to those described in the illustrated embodiments. The directions may be adequately selected or different directions may be adequately combined, to obtain the desired decorative design presented on the decorative design surface 16, or to control fluidity of the resin-impregnated ligneous material 30 (or the resin-impregnated sliced veneer sheet 30a) in the flow molding process.

Further, the ligneous substrate 12 may be formed from a bamboo, in place of the lumber.

The forms of the ligneous materials (the sliced veneer and the substrate-layer forming block) are not limited to the rectangular block and the flat sheet used in the illustrated embodiments. For instance, the ligneous materials may take the form of chips or pieces of lumber or bamboo obtained by braking, chopping or cutting. Irrespective of any specific form of the ligneous materials, the fiber cell walls of the ligneous materials are required to be impregnated with a thermosetting resin material.

Although the fiber cells of the ligneous material of the ligneous substrate 12 are required to be impregnated with a thermosetting resin material according to the present invention, the resin material need not be contained in the fiber cell walls. For instance, the resin material may be merely accommodated in internal pores of the fiber cells. In this case, the ligneous material is preferably subjected to a known acetylation treatment to cut the hydrogen bonds among the fiber cells of the ligneous material, before the ligneous material is impregnated with the resin material.

Further, the principle of the present invention is equally applicable to a formed ligneous body other than an automotive vehicle interior part, and a method of producing the same.

It is to be understood that the present invention may be embodied with various changes, modifications and improvements which are not described herein, and which may occur to those skilled in the art, without departing from the spirit and scope of this invention.

1. A formed ligneous body having a ligneous substrate whose front surface serves as a decorative design surface, and a clear layer which is integrally formed on the decorative design surface of the ligneous substrate and which has translucency, wherein
the ligneous substrate is formed by subjecting a ligneous material impregnated with a thermosetting resin material, to a flow molding process in which the ligneous material is heated and pressed such that the ligneous material is forced to flow and shaped while the ligneous material is compressed, and the clear layer is formed by heating and pressing at least one fibrous sheet constituted by plant fibers and impregnated with a thermosetting resin material, together with the ligneous material during said flow molding process, so that the at least one fibrous sheet is made transparent.

2. The formed ligneous body according to claim 1, wherein the thermosetting resin material contained in the ligneous material of the ligneous substrate is at least one of a melamine resin and a urea resin, and the thermosetting resin material contained in the at least one fibrous sheet of the clear layer is at least one of the melamine resin and the urea resin.

3. The formed ligneous body according to claim 1, wherein both of the thermosetting resin material contained in the ligneous material of the ligneous substrate and the thermosetting resin material contained in the at least one fibrous sheet of the clear layer are a melamine resin.

4. The formed ligneous body according to claim 1, wherein the at least one fibrous sheet contains at least one additive selected from the group consisting of a coloring agent, a light resistant agent, an ultraviolet-absorbing agent, a heat-absorbing agent and an anti-oxidizing agent, together with the thermosetting resin material, so that the clear layer contains the at least one additive.

5. The formed ligneous body according to claim 1, wherein the clear layer has a thickness within a range of 400-600 μm.

6. The formed ligneous body according to claim 1, wherein the ligneous material includes a sliced veneer which is sliced from a lumber in a direction parallel to a direction of extension of fibers of the lumber and which is impregnated with the thermosetting resin material, and a sliced veneer layer is formed from the sliced veneer in a portion of the ligneous substrate on the side of its front surface.

7. A method of producing the formed ligneous body as defined in claim 1, comprising the steps of:
providing a ligneous material impregnated with a thermosetting resin material and at least one fibrous sheet constituted by plant fibers and impregnated with a thermosetting resin material;
accommodating said ligneous material and said at least one fibrous sheet in a forming cavity, such that the at least one fibrous sheet is placed on the side of a cavity surface and the ligneous material is superposed on the at least one fibrous sheet;
heating and pressing the at least one fibrous sheet while subjecting the ligneous material to a flow molding process by heating and pressing the ligneous material in the forming cavity such that the ligneous material is forced to flow and shaped while the ligneous material is compressed in a direction of mutual superposition of the ligneous material and the at least one fibrous sheet; and
curing or solidifying the thermosetting resin materials respectively contained in the ligneous material and in the at least one fibrous sheet, while heating and pressing the ligneous material and the at least one fibrous sheet, so that the at least one fibrous sheet is made transparent, and said ligneous substrate and said clear layer are formed integrally with each other in the forming cavity.

8. The method according to claim 7, wherein the ligneous material is a rectangular block cut from a lumber in a direction perpendicular to a direction of extension of fibers of the lumber.

9. The method according to claim 7, wherein the at least one fibrous sheet comprises a plurality of fibrous sheets, and the plurality of fibrous sheets are superposed on each other and accommodated within said forming cavity.

10. A method of producing the formed ligneous body as defined in claim 6, comprising the steps of:
providing a ligneous material which includes a sliced veneer and which is impregnated with a thermosetting resin material, and at least one fibrous sheet constituted by plant fibers and impregnated with a thermosetting resin material;
accommodating said ligneous material and said at least one fibrous sheet in a forming cavity, such that the at least one fibrous sheet is placed on the side of a cavity surface, and the ligneous material is superposed on the at least one fibrous sheet such that said sliced veneer is disposed on the side of the at least one fibrous sheet;
heating and pressing the at least one fibrous sheet while subjecting the ligneous material to a flow molding process by heating and pressing the ligneous material in the forming cavity, such that the ligneous material is forced to flow and shaped while the ligneous material is compressed in a direction of mutual superposition of the ligneous material and the at least one fibrous sheet; and
curing or solidifying the thermosetting resin materials respectively contained in the ligneous material and in the at least one fibrous sheet, while heating and pressing the ligneous material and the at least one fibrous sheet, so that the at least one fibrous sheet is made transparent, and said ligneous substrate and said clear layer are formed integrally with each other in the forming cavity.
